(19) United States
(12) Patent Application Publication
(10) Pub. No.: US 2025/0355641 A1
(43) Pub. Date: Nov. 20, 2025

(54) AI AGENT ARCHITECTURE PLATFORM FOR MANAGING SOFTWARE DEVELOPMENT PROCESS

(71) Applicant: Stride Consulting, LLC, New York, NY (US)

(72) Inventors: Debra Fran MADDEN, New York, NY (US); Francisco Jose Martin GARCIA, Seattle, WA (US); Ako GAGARIN, Manor, TX (US); Michael CARLSON, Brooklyn, NY (US); Ramond LAM, Mount Prospect, IL (US); Josiah Joash WILKINS, Queens, NY (US); Daniel M. MASON, Rumson, NJ (US); David ANDERSON, New Preston, CT (US)

(73) Assignee: Stride Consulting, LLC, New York, NY (US)

(21) Appl. No.: 18/664,344

(22) Filed: May 15, 2024

(51) Int. Cl. G06F 8/35; G06F 8/10

(52) U.S. Cl. CPC G06F 8/35; G06F 8/10

(57) ABSTRACT

The disclosed technology provides for an improved approach to AI code generation. In various embodiments, the disclosed technology provides for an AI agent architecture platform for generating, revising, testing, and debugging code using a customizable team of agents with specific tasks.

### FIELD OF THE INVENTION

The invention relates to an artificial intelligence (AI) agent architecture platform for managing a software development process and coordinating the operation and interaction of multiple AI agents based on specified requirements to generate a set of tasks, determine which agents should be assigned to perform which tasks, determines a set of files (e.g., from a vector database), provide the files to the relevant agents to perform their respective tasks (e.g., write, evaluate, revise, test and debug code) and generate a script to modify files on a local machine.

### BACKGROUND

AI code generators in general are known. AI code generators can harness the power of Large Language Models (LLMs) to assist developers in writing code more efficiently. For example, some comprise AI models that are trained on open source or other code repositories. Often AI code generators operate alongside a software development environment (e.g., IDE) and assist a developer as they are writing code. For example, AI code generators can operate in some instances like an auto complete tool by suggesting code to a developer as they are writing it. The AI code generator analyzes the code in real time and can comment or provide suggestions in real time. AI code generators can help reduce the time it takes for developers to write code. However, they are limited in function and have other known drawbacks.

AI agents are also generally known. AI agents for writing software are autonomous computer programs that perform tasks with little or no human involvement. They can assist developers in various aspects of code writing. These agents use AI techniques to enhance productivity in code writing. As opposed to LLMs, agents can be more task specific. For example, certain agents may be created to assist with specific programming languages or to perform specific tasks.

An AI agent can be a computational entity equipped with algorithms, knowledge bases, and/or communication abilities. AI agents can act independently to achieve defined goals without continual human intervention. Various tools are known to develop AI agents. In many cases, AI coding agents operate independently. For example, each performs its designed function when called by the developer. Many are command-line tools that run along side a developers development environment on their local machine. Known AI coding agents have various known limitations and drawbacks. AI agents may be designed to understand and process natural language, enabling them to interact with humans in a natural and intuitive manner.

### SUMMARY

The invention relates to an AI agent architecture platform for managing a software development process and coordinating the operation and interaction of multiple AI agents based on specified requirements to generate a set of tasks, determines a set of files (e.g., from a vector database), provide the files to selected agents to perform parts of the tasks (e.g., to write, evaluate, revise, test and debug code) and generate a script to modify files on a local machine. For example, a developer may have a local development environment on a local machine.

A developer or other entity may specify a set of requirements (e.g., a functional specification for a software application, improvements to existing software or other requirements). The requirements may be in text form.

A conductor module may connect to the developer's local machine via the code context agent to access the local code. The accessed code may be stored in a database, which may comprise a vector database. A Retrieval-Augmented Generation (RAG) software module makes that code searchable by an LLM. RAGs in general are known. The LLM may be stored with or accessible by the platform.

The AI agent architecture platform may comprise various components as further described below. For example, the platform may include a conductor module and may include one or more of a code context agent, a requirements refiner agent, a vector database, a planner agent, and engineer lead agent and a set of agents identified for the tasks needed to meet the requirements. The agents may include, for example, one or more coder agents, critic agents, test writer agents, debugger agents and/or other agents. The agents in the identified set of agents may be configured as a group and have communications functionality associated with the agents to enable communication between the agents. The communication between an identified set of agents may be referred to as a group chat among those agents.

The requirements refiner agent may retrieve the relevant code from the database and the requirements information and communicate them to the planner agent and engineering lead agent. These agents build a functional/technical plan of what is supposed to happen next. They output the tasks that needs to be done. Tasks may be individual assignments that agents complete. They encapsulate necessary information for execution and may include a description of the task and an assigned agent, among other information. Tasks can be designed to require collaboration between agents. For example, one agent might gather data while another analyzes it. This collaborative approach can be defined within the task properties and managed by processes. The planner agent and engineering lead agent output may be a stream in conversation form regarding what needs to be done. This may include determining which files need to be taken from vector database to feed into other agents along with a description of the tasks each agent is to perform and identification of to which agents to send specific tasks.

To build a functional/technical plan, the planner agent begins by ingesting user requirements and existing project context from the code context agent. Based on the user requirements and the existing project context, the planner agent constructs an abstract representation of a problem to be solved or a goal to be achieved by the functional/technical plan. The abstract representation can be constructed, for example, using predicate logic. The planner agent uses a hierarchical task network planning approach to recursively decompose the problem to be solved or the goal to be achieved by the functional/technical plan into subproblems/subgoals and primitive tasks. Based on the recursive decomposition, the planner agent generates a partially ordered graph of tasks. The planner agent communicates the partially ordered graph of tasks to the coder agent, which in turn sequentially generates code for each task in the ordered graph of tasks. The generated code is reviewed by the engineering lead agent for approval and feedback. The feedback generated by the engineering lead agent can be provided as existing project context for a subsequent iteration of the process described, building subsequent functional/technical plans that incorporate the feedback generated by the engineering lead agent. The process can be reiterated until the engineering lead agent provides approval.

The identified agents may comprise a configured set of agents. The set of agents identified for the tasks needed to meet the requirements, which for example, may include one or more coder agents, critic agents, test writer agents, debugger agents and/or other agents. The agents in the identified set of agents may be configured as a group and have communications functionality associated with the agents to enable communication between the agents. The communication between an identified set of agents may be referred to as a group chat among those agents.

Each agent may be configured to perform specific tasks. The configuration of agents to perform specific tasks in general is known. One or more coder agents may interpret the tasks and create code to accomplish those tasks. One or more critic agents may evaluate the plan (e.g., functional/technical plan) and/or outputs of the one or more coder agents and determine if the plan and/or outputs are acceptable or not. It may communicate its determinations/recommendations to the one or more coder agents.

The one or more critic agents can determine whether the outputs of the one or more coder agents are based on an evaluation of the outputs and corresponding tasks from the plan. The one or more critic agents can indicate the outputs are acceptable based on a determination the outputs of the one or more coder agents do satisfy the corresponding tasks from the plan. The one or more critic agents can indicate the outputs are not acceptable based on a determination the outputs of the one or more coder agents do not satisfy the corresponding tasks from the plan. In cases where the one or more critic agents indicate the outputs are not acceptable, the one or more critic agents can provide recommendations identifying which tasks are not satisfied identifying which outputs do not satisfy a task.

One or more test writer agents can write tests for the code created by the code creator agents. One or more debugger agents can debug the code output by the code creator agents.

One of the unique aspects of the platform is that the group chat function of the identified set of agents enables the agents to communicate with any other agent in any order. The agents may operate in parallel and the output of one agent may be provided as input to another agent, in any order. This enables a flexible, collaborative capability among the agents and greater efficiency. The group chat function of the platform facilitates communication between agents through a shared message thread.

Collectively, the set of agents in the group chat produce a script that that is provided to the developer's local machine and make changes to the local files as necessary to accomplish the requirements/tasks. The developer can commit the change to the local development environment.

The developer may review the updated files, perform any code and functional checks to determine the suitability of the code. If further changes are needed, the developer can provide feedback to the platform as new requirements. The new requirements are processed as detailed above and the agents iteratively operate to produce a script. This process may be repeated as necessary until the developer is satisfied with the code. The code can then be deployed.

The multi-agent platform may be configured to enable communication, collaboration and decisions by different AI agents. The platform leverages the capabilities of the combination of an identified set of intelligent AI agents, each with their own AI attributes, to achieve better results than systems with single-agent implementations. AI agents may be connected to one or more LLMs.

Various tools for creating individual agents are known. Various AI agents can be created, in a generally known manner, by defining roles and goals for the agent and configuring it to perform various tasks. An AI agent can be an autonomous entity programmed with computer instructions to perform tasks, make decisions and communicate with other agents. The agents may be conversational agents that can communicate with each other (and other components) using natural language or other methods.

Each agent may have a set of agent attributes. The attributes may include, for example, one or more of the following attributes and/or other attributes.

| Attribute | Description |
|---|---|
| Role | Defines the agent's function. It determines the kind of tasks the |
| | agent is best suited for. |
| Goal | The individual objective that the agent aims to achieve. It guides |
| | the agent's decision-making process. |
| Backstory | Provides context to the agent's role and goal, enriching the |
| | interaction and collaboration dynamics. |
| LLM | The language model used by the agent to process and generate text. |
| | It dynamically fetches the model name from |
| | the OPENAI_MODEL_NAME environment variable. A default may be |
| | used if none specified |
| Tools | Set of capabilities or functions that the agent can use to perform |
| | tasks. Tools can be shared or exclusive to specific agents. It's an |
| | attribute that can be set during the initialization of an agent, with a |
| | default value of an empty list. |
| Function | If passed, this agent will use this LLM to execute function calling |
| Calling | for tools instead of relying on the main LLM output. |
| LLM | |
| Max Iter | The maximum number of iterations the agent can perform before |
| | being forced to give its best answer. A default value may be set if |
| | none is specified. |
| Max RPM | The maximum number of requests per minute the agent can |
| | perform to avoid rate limits. It's optional and can be left |
| | unspecified, with a default value. |
| Verbose | Enables detailed logging of the agent's execution for debugging or |
| | monitoring purposes when set to True. Default may be False. |
| Allow | Agents can delegate tasks or questions to one another, ensuring that |
| Delegation | each task is handled by the most suitable agent. Default may |
| | be True. |
| Step | A function that is called after each step of the agent. This can be |
| Callback | used to log the agent's actions or to perform other operations. |
| Memory | Indicates whether the agent should have memory or not. This |
| | impacts the agent's ability to remember past interactions. The |
| | default value may be False. |

Not every agent need have each of these attributes. Some agents may also have other attributes.

Each task may have a set of task attributes. The attributes may include, for example, one or more of the following attributes and/or other attributes.

| Attribute | Description |
|---|---|
| Description | A clear, concise statement of what the task entails. |
| Agent | Can specify which agent is responsible for the task or enables agents |
| | to determine which agent should handle the task (e.g., see consensual |
| | processes below) |
| Expected | Clear and detailed definition of expected output for the task. |
| Output | |
| Tools | These are the functions or capabilities the agent can utilize to |
| | perform the task. They can be anything from simple actions like |
| | search' to more complex interactions with other agents or APIs. |
| Async | Indicates whether the task should be executed asynchronously, |
| Execution | allowing the crew to continue with the next task without waiting for |
| | completion. |
| Context | Other tasks that will have their output used as context for this task. If |
| | a task is asynchronous, the system will wait for that to finish before |
| | using its output as context. |
| Output | Takes a file path and saves the output of the task on it. |
| File | |
| Callback | A function to be executed after the task is completed. |

Not every task need have each of these attributes. Some tasks may also have other attributes.

As detailed below, various processes can be programmed to define how the agents work together, how tasks are assigned and the interaction between agents. However, intelligent AI agents may operate dynamically and learn over time to improve their performance based on feedback they receive as they perform tasks.

Processes can manage the execution of tasks by agents. These processes can be designed so that tasks are distributed and executed efficiently. Processes enable individual agents to operate collectively to perform specific tasks that are all part of what are needed to achieve the goals of a common requirement specification.

In some aspects, the execution of tasks by agents can be managed by a configurable runtime for the agents. The configurable runtime for the agents can be based on a configuration file. The configuration file can define a team of agents and use the agents to run code generation and code review workflows. For example, the configuration file can specify a team of agents, a workflow structure, a type for each agent, assignments for each agents to workflows in the workflow structure (e.g., a first set of agents assigned to write code, a second set of agents assigned to write tests), mapping of prompts to agent types, agent speaking order (e.g., automatized priority, specified priority), hyperparameters for LLMs, code languages, and test commands. During runtime, the team of agents can be instantiated based on the configuration file. A codebase can be loaded, for example, via a code context agent. A set of initial tasks can be scheduled, for example, via a planner agent. The runtime can provide a messaging bus for the team of agents to communicate asynchronously. A distributed data store where intermediate results are cached can be shared by the team of agents. The runtime can monitor overall progress and resource utilization.

The runtime instantiates the specified agents, loads the codebase into context and schedules the initial tasks. It provides a messaging bus for agents to communicate asynchronously. Intermediate results are cached and shared via a distributed data store. The runtime monitors overall progress and resource utilization.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined by the claims attached hereto.

### BRIEF DESCRIPTION OF THE DRAWINGS

FIG. 1 illustrates an example system, according to various embodiments of the disclosed technology.

FIG. 2 illustrates an example flow, according to various embodiments of the disclosed technology.

FIG. 3 illustrates an example computing system, according to various embodiments of the disclosed technology.

The figures are not intended to be exhaustive or to limit the invention to the precise form disclosed. It should be understood that the invention can be practiced with modification and alteration and that the disclosed technology be limited only by the claims and the equivalents thereof.

### DETAILED DESCRIPTION

AI code generators can assist a developer as they are writing code by suggesting code to the developer based on the code the developer has written. In this way, AI code generators function similar to autocomplete tools except that AI code generators suggest functional code to finish a line of code instead of words to finish a sentence. While AI code generators can assist developers to generate code faster and reduce the need for manual writing, AI code generators may not generate useful code. For example, code suggested by AI code generators may syntactically complete a line of code but fail to function as intended by the developer writing the line of code. Accordingly, AI code generators are limited in function and utility.

An improved approach to AI code generation overcomes the aforementioned and other technological challenges. In various embodiments, the disclosed technology provides for an AI agent architecture platform for generating, revising, testing, and debugging code using a customizable team of agents with specific tasks. In general, the AI agent architecture platform can various agents including, for example, one or more requirements refiner agents, one or more code context agents, one or more planner agents, one or more engineering lead agents, one or more coder agents, one or more critic agents, one or more test writer agents, and one or more debugger agents. The requirements refiner agents can generate requirements appropriate for a functional/technical plan based on developer-requested requirements, including requested features, requested products, existing backlogs, and developer-provided feedback. The code context agents can provide context for the functional/technical plan, including contextually labeled code for a vector database based on an existing codebase (e.g., from a local development environment). The planner agents in coordination with the engineering lead agents can generate a functional/technical plan that outlines a set of tasks to be performed based on the requirements from the requirements refiner agents and the context from the code context agents. The functional/technical plan is executed by a set of agents comprising the coder agents, the critic agents, the test writer agents, and the debugger agents. The set of agents can coordinate via a shared message thread to collaboratively perform the set of tasks outlined by the functional/technical plan in parallel. Collectively, the set of agents generate a script that causes revisions (e.g., additions, removals, modifications) to be made to the existing codebase in accordance with the developer-requested requirements. Thus, through the use of multiple agents, the AI agent architecture platform can provide for meaningful change to a codebase based on developer-requested requirements.

To further illustrate the improved approach of the disclosed technology, the set of agents that executes the functional/technical plan can comprise agents with specific roles and configurations that synergistically improves the performance of the set of agents as a whole. For example, the set of agents comprises coder agents. The coder agents can perform roles related to code generation and generate code based on tasks specified in the functional/technical plan. The set of agents comprises critic agents. The critic agents can perform roles related to code critique and evaluate whether code generated by the coder agents satisfy the tasks specified in the functional/technical plan. The set of agents comprises test writer agents. The test writer agents can perform roles related to test writing and generate tests for evaluating the code generated by the coder agents based on the tasks specified in the functional/technical plan. In some cases, the critic agents can evaluate the code generated by the coder agents based on the tests generated by the test writer agents and results from applying the code generated by the coder agents to the tests generated by the test writer agents. The set of agents comprises debugger agents. The debugger agents can perform roles related to code debugging and identify bugs and bug fixes for the code generated by the coder agents based on the functional/technical plan. The set of agents can communicate with each other via a shared message thread in which the outputs of the agents are shared, allowing each agent to use, as inputs, the outputs of the other agents. Thus, through the collaboration of multiple agents, the AI agent architecture platform can facilitate code generation that has been debugged and optimized to satisfy developer-requested requirements.

As an example of the disclosed technology, a developer can utilize the AI agent architecture platform to add a new function to an existing codebase. The developer can provide requested requirements for what the new function does in the form of narrative text prompts. A requirements refiner agent can generate a set of requirements based on the developer-requested requirements for the new function. The set of requirements can, for example, include text instructions that a planner agent and an engineering lead agent can interpret to generate a functional/technical plan. The existing codebase can be provided to a code context agent that labels the code for a vector database. For example, the existing codebase can be used as context by the planner agent and the engineer lead agent to identify one or more portions of the existing codebase to implement the new function. The planner agent and the engineering lead agent can collaboratively generate the functional/technical plan based on the requirements from the requirements refiner and the context from the code context agent. The functional/technical plan can include a set of tasks to implement the new function in the existing codebase. The functional/technical plan can be provided to a set of agents comprising a coder agent, a critic agent, a test writer agent, and a debugger agent. Based on the functional/technical plan, the coder agent can generate code that satisfies the set of tasks in the functional/technical plan and the test writer agent can generate tests for evaluating whether the code generated by the coder agent satisfies the set of tasks. The generated code and the generated tests are shared via a shared message thread with the critic agent and the debugger agent. Based on the generated code and the generated tests, the critic agent evaluates whether the generated code satisfies the set of tasks, and the debugger agent identifies any bugs in the generated code. The evaluation by the critic agent and the bugs identified by the debugger agent are shared via the shared message thread with the coder agent and the test writer agent. The coder agent and the test writer agent can use this feedback to generate more code and more tests. This communication between the set of agents continues until code that satisfies the set of tasks in the functional/technical plan is generated. From the generated code, a script to modify the existing codebase to implement the new function can be generated. As illustrated in this example, the AI agent architecture platform leverages multiple agents to generate refined code based on requested requirements from a developer. This and other advantages of the disclosed technology are described in further detail herein.

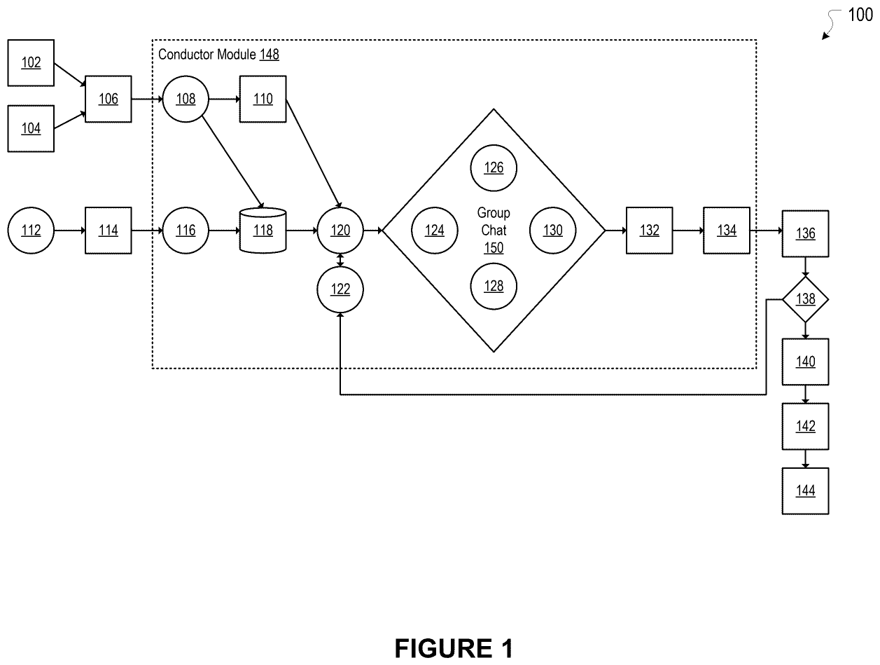

FIG. 1 illustrates an example system 100 including an AI agent architecture platform, according to various embodiments of the disclosed technology. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functions described in connection with the AI agent architecture platform can be implemented in various suitable combinations and in various suitable environments. For example, the AI agent architecture platform can be implemented in a computing system.

In various embodiments, the AI agent architecture platform can be implemented, in part or in whole, as software, hardware, or any combination thereof. In general, a module as discussed herein can be associated with software, hardware, or any combination thereof. In various embodiments, one or more functions, tasks, and/or operations of modules can be carried out or performed by software routines, software processes, hardware, and/or any combination thereof. In various embodiments, the components of the AI agent architecture platform can be implemented as software running on one or more computing devices or systems, such as on a computing system or a client computing device. For example, some components of the AI agent architecture platform can be implemented as or within a dedicated application running on a client computing device. Many variations are possible.

As illustrated in FIG. 1, the example system 100 includes a conductor module 148. The conductor module 148 can include a customizable team of agents that facilitate generating, revising, testing, and debugging code. In general, an agent is an artificial intelligence system that uses a large language model as its central computational engine. Such LLM-based agents are capable of independently performing tasks based on instructions and information that can be provided through one or more text prompts. For example, an agent can be prompted with context (e.g., capabilities, behaviors, roles) by which to perform a task (e.g., command, instruction). The agent can generate a response based on the context and the task. In some instances, an LLM-based agent can be fine-tuned to perform specific tasks. In these instances, the LLM-based agent can be trained based on training data demonstrating instances of a specific task to be performed. By further training the LLM-based agent, the LLM-agent can be fine-tuned to perform the specific task. For example, an LLM-based debugger agent can be fine-tuned to identify poor programming style as potential bugs. The debugger agent can be trained based on instances of training data that include example code labeled to identify the portions of the example code that exhibit poor programming style. By further training the debugger agent, the debugger agent can be trained to not only identify bugs but also to identify poor programming style as potential bugs. In some instances, an agent can be based on a machine learning model trained to perform a specific role. For example, a critic agent can be based on a machine learning model trained with instances of training data that include example code labeled as negative (e.g., bad) code and example code labeled as positive (e.g., good) code. Based on the training data, the critic agent can be trained to identify instances of bad code and good code. It should be understood that many variations are possible. While the various examples described herein may be implemented using LLM-based agents, the disclosed technology is not limited to LLM-based agents.

In the example system 100, the conductor module 148 receives developer-provided information 106. The developer-provided information 106 can include, for example, development notes, backlogs, reported issues, and the like. The developer-provided information 106 can also incorporate developer-requested requirements such as requested features 102 and requested products 104. The developer-provided information is provided to a requirements refiner agent 108. Based on the developer-provided information 106, the requirements refiner agent 108 can generate a set of requirements 110 that the team of agents understands for determining tasks to perform and benchmarks to satisfy. The requirements refiner agent 108 can clarify and decompose the developer-requested requirements using the codebase as context and create stories, acceptance criteria, and implementation notes for the team of agents. In some cases, the requirements refiner agent 108 can identify information that serves as context for a codebase and provides the information to a vector database 118.

The conductor module 148 has access to a local development environment 114, which can include a codebase on which to generate, revise, test, and debug code. The local development environment 114 can be provided, for example, by a developer 112. Access to the local development environment 114 and the codebase of the local development environment 114 is provided to a code context agent 116. The code context agent 116 can ingest the codebase and build a semantic representation of the codebase that captures relationships between code elements of the codebase. The code context agent 116 can provide relevant code and inline documentation as context that can be used by other agents. Based on the local development environment, the code context agent 116 can generate context, including contextually labeled code, which is provided to the vector database 118.

The conductor module 148 can include a planner agent 120 and an engineer lead agent 122 that generate a functional/technical plan based on the set of requirements 110 and the vector database 118. In general, the functional/technical plan comprises a set of tasks to complete and a set of targets that performance of the set of tasks are to meet to satisfy the set of tasks. The planner agent 120 can identify resources (e.g., code, agents) and associate tasks to be performed to the resources based on the set of requirements 110. The planner agent 120 constructs an abstract representation of requirements (e.g., the problem to be solved) using predicate logic. The planner agent 120 then uses a hierarchical task network planning approach to recursively decompose the requirements into goals, subgoals, and primitive tasks. The planner agent 120 can maintain a sequential task queue for performing the set of tasks. The resulting functional/technical plan is the set of tasks, which can be ordered, partially ordered, or unordered. For example, the planner agent 120 can identify a coder agent 124 and a portion of a codebase to implement a new function and associate tasks related to code generate to the coder agent 124 and the portion of the codebase. The engineer lead agent 122 can determine technical targets for tasks associated by the planner agent 120. The tasks can be determined to be satisfied based on satisfaction of the technical targets for the tasks. For example, the engineer lead agent 122 can identify tasks to be evaluated by tests and determine targets to be satisfied by the tests. Tasks associated with writing the tests can be provided, for example, to a test writer agent 128. Based on the tasks and targets determined by the planner agent 120 and the engineer lead agent 122, a functional/technical plan can be generated.

The functional/technical plan includes a set of tasks for the agents to perform. Each task may have a set of task attributes. An example of the set of task attributes is provided here.

| Attribute | Description |
|---|---|
| Description | A clear, concise statement of what the task entails. |
| Agent | Can specify which agent is responsible for the task or enables agents |
| | to determine which agent should handle the task (e.g., see consensual |
| | processes below) |
| Expected | Clear and detailed definition of expected output for the task. |
| Output | |
| Tools | These are the functions or capabilities the agent can utilize to |
| | perform the task. They can be anything from simple actions like |
| | search' to more complex interactions with other agents or APIs. |
| Async | Indicates whether the task should be executed asynchronously, |
| Execution | allowing the crew to continue with the next task without waiting for |
| | completion. |
| Context | Other tasks that will have their output used as context for this task. If |
| | a task is asynchronous, the system will wait for that to finish before |
| | using its output as context. |
| Output | Takes a file path and saves the output of the task on it. |
| File | |
| Callback | A function to be executed after the task is completed. |

The functional/technical plan can be provided to a group chat 150 of agents. In the example system 100, the group chat 150 can include the coder agent 124, the test writer agent 128, a critic agent 126, and a debugger agent 130. As part of the group chat 150, the coder agent 124, the test writer agent 128, the critic agent 126, and the debugger agent 130 have access to the functional/technical plan via a shared message thread. Based on the set of tasks and the set of targets in the functional/technical plan, the coder agent 124 the test writer agent 128, the critic agent 126, and the debugger agent 130 identify and perform their respective tasks. For example, the coder agent 124 can identify tasks related to code generation and perform the tasks to generate code. The coder agent 124 can generate code for a task using existing code for context and implementing or improving upon existing patterns. The test writer agent 128 can identify tasks related to test generation and perform the tasks to generate tests for the code generated by the coder agent 124. The test writer agent 128 can generate test cases covering functional requirements and edge cases using templates and mutation techniques to ensure adequate coverage. The critic agent 126 can identify targets associated with the tasks to be performed and evaluate the code generated by the coder agent 124 based on the targets. The debugger agent 130 can identify tasks related to code generation and targets associated with these tasks to evaluate code generated by the coder agent 124 for bugs. The debugger agent 130 can instrument code with breakpoints and tracing, execute tests, and apply root cause analysis to identify and localize faults. As the coder agent 124, test writer agent 128, the critic agent 126, and the debugger agent 130 perform their respective tasks, their outputs are shared via the shared message thread. The coder agent 124, the test writer agent 128, the critic agent 126, and the debugger agent 130 can take these outputs as input to further refine their tasks. For example, the coder agent 124 can generate revised code based on an evaluation output by the critic agent 126 and identification of bugs output by the debugger agent 130. The critic agent 126 can provide an evaluation of code generated by the coder agent 124 based on the code output by the coder agent 124 and tests output by the test writer agent 128. Using the shared message thread, the coder agent 124, the test writer agent 128, the critic agent 126, and the debugger agent 130 can communicate and share their outputs until the set of tasks in the functional/technical plan have been performed to satisfaction of the set of targets in the functional/technical plan.

The group chat 150 produces a collection 132 that collects the code, tests, documentation, and chatlogs output from the agents of the group chat 150. The collection 132 can be used, for example, by the engineer lead agent 122 to identify errors, bugs, and other issues that may have occurred during performance of the functional/technical plan. Based on the collection 132, a script 134 for enacting change to the codebase can be generated. The script 134 can, for example, enact a GitHub commit. The script 134 can be enacted in the codebase to provide a local development environment with new features 136. The local development environment with new features 136 can be evaluated 138 by the engineer lead agent 122 to determine whether the requirements 110 were satisfied. If the engineer lead agent 122 determines the requirements 110 were satisfied, then the local development environment with new features 136 can be provided for code review 140. The code review 140 can be performed, for example, by the developer 112. The local development environment with new features 136 can then be merged 142 with the local development environment 114 at which point the changes enacted by the conductor module 148 are live 144.

If the engineer lead agent 122 determines the requirements 110 were not satisfied, then with the planner 120, a new functional/technical plan can be generated to account for the errors, bugs, and other issues that occurred. In some respects, the engineer lead agent 122 and the planner 120 uses the script 134 as additional context to the vector database 118 and the requirements 110 to generate the new functional/technical plan.

In some instances, the developer 112 can review the local development environment with new features 136 and provide feedback that serves as context for further development of the new functional/technical plan. To facilitate developer review, the agents can be prompted to provide rationale for design decisions, which can be stored as code comments and documentation. For example, the developer 112 can provide express feedback on generated code quality, readability, and correctness. The developer 112 can provide implicit feedback based on edits and overrides to the generated code. In some instances, the developer 112 can provide feedback at various points in the code generation process, including providing feedback regarding the relevance and clarity of agent prompts and agent messages in the shared message thread. The feedback provided by the developer 112 can be processed by the requirements refiner agent 108 as an additional set of developer-requested requirements. The codebase on which the developer 112 provided feedback can be processed by the code context agent 116 as an additional set of context. These additional requirements and additional context can impact the AI agent architecture platform globally to improve the agents of the AI agent architecture platform with each round of feedback. By incorporating feedback from the developer 112, the AI agent architecture platform can iteratively improve the quality and relevance of the code it generates and adapt to specific needs and preferences of the developer 112.

It should be understood that, while FIG. 1 illustrates one example system 100, the AI agent architecture platform of the disclosed technology comprises customizable teams of customizable agents. For example, agents of the AI agent architecture platform can be customized based on a configuration file. The configuration file can define a team of agents for the AI agent architecture platform by specifying which agents are included in the team and what attributes the agents have. Based on the configuration file, a team of agents can be configured at runtime to run code generation and code review workflows. The configuration file can define an agent with a set of attributes including, for example, name, role, functions to execute, access to a vector database, access to developer-requested requirements, and the like. An example set of agent attributes is provided here.

| Attribute | Description |
|---|---|
| Role | Defines the agent's function. It determines the kind of tasks the |
| | agent is best suited for. |
| Goal | The individual objective that the agent aims to achieve. It guides |
| | the agent's decision-making process. |
| Backstory | Provides context to the agent's role and goal, enriching the |
| | interaction and collaboration dynamics. |
| LLM | The language model used by the agent to process and generate text. |
| | It dynamically fetches the model name from |
| | the OPENAI_MODEL_NAME environment variable. A default may be |
| | used if none specified |
| Tools | Set of capabilities or functions that the agent can use to perform |
| | tasks. Tools can be shared or exclusive to specific agents. It's an |
| | attribute that can be set during the initialization of an agent, with a |
| | default value of an empty list. |
| Function | If passed, this agent will use this LLM to execute function calling |
| Calling | for tools instead of relying on the main LLM output. |
| LLM | |
| Max Iter | The maximum number of iterations the agent can perform before |
| | being forced to give its best answer. A default value may be set if |
| | none is specified. |
| Max RPM | The maximum number of requests per minute the agent can |
| | perform to avoid rate limits. It's optional and can be left |
| | unspecified, with a default value. |
| Verbose | Enables detailed logging of the agent's execution for debugging or |
| | monitoring purposes when set to True. Default may be False. |
| Allow | Agents can delegate tasks or questions to one another, ensuring that |
| Delegation | each task is handled by the most suitable agent. Default may |
| | be True. |
| Step | A function that is called after each step of the agent. This can be |
| Callback | used to log the agent's actions or to perform other operations. |
| Memory | Indicates whether the agent should have memory or not. This |
| | impacts the agent's ability to remember past interactions. The |
| | default value may be False. |

In some instances, a team of agents can be configured based on developer-requested requirements. For example, a requirements refiner agent can generate requirements based on developer-requested requirements. A planner agent and an engineer lead agent can generate a functional/technical plan based on the requirements generated by the requirements refiner agent. Based on the functional/technical plan, a team of agents can be configured to address the set of tasks in the functional/technical plan. For example, for a set of tasks that mostly involves debugging code without generating new code, a critic agent may not be used in the team of agents. For a set of tasks that prioritize a certain function (e.g., code generation, debugging), additional agents can be added to emphasize the function. Many variations are possible.

In some instances, a workflow for a team of agents can be configured based on a configuration of the team of agents and a functional/technical plan for the team of agents. For example, the functional/technical plan can provide a sequence of tasks to be performed, and a workflow for the team of agents can be configured so that the tasks are performed in sequence instead of, for example, in parallel. The workflow may be configured to have the team of agents perform a set of tasks in a sequence based on certain tasks in the set of tasks being dependent on other tasks in the set of tasks. Many variations are possible.

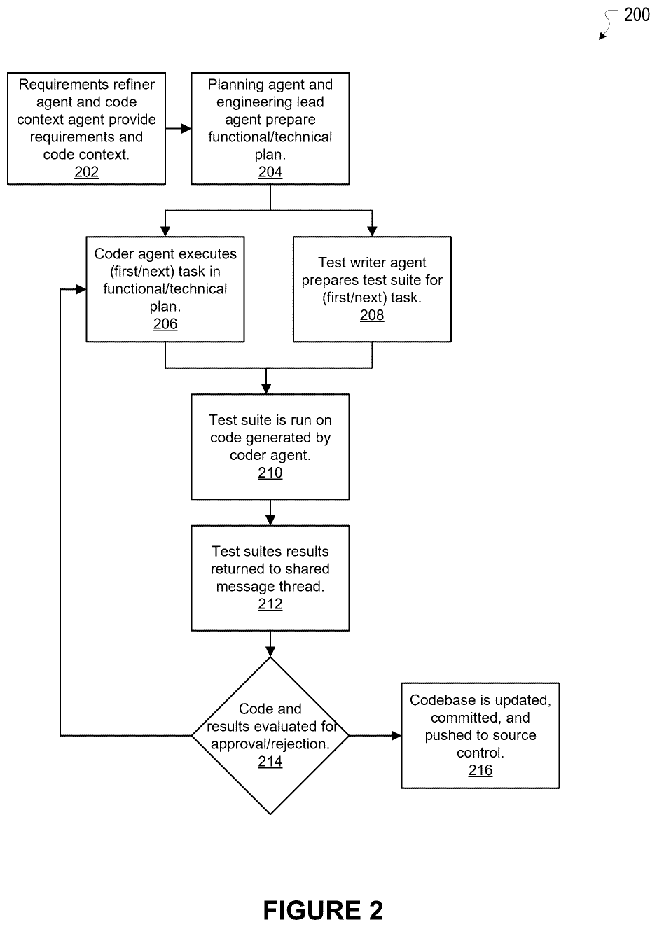

FIG. 2 illustrates an example flow 200, according to various embodiments of the disclosed technology. The example flow 200 can be associated with one or more functions performed by the system 100 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

As illustrated in FIG. 2, at 202, a requirements refiner agent and a code context agent provide requirements and code context. The requirements and the code context can be based on, for example, developer-requested requirements and an existing codebase. At 204, a planning agent and an engineering lead agent prepare a functional/technical plan. The functional/technical plan can, for example, include a set of tasks to be performed by a team of agents. At 206, a coder agent executes the set of tasks in the functional/technical plan. The coder agent can execute the set of tasks to, for example, generate code in accordance with the functional/technical plan. At 208, a test writer agent prepares a test suite for the set of tasks. As illustrated in FIG. 2, the coder agent and the test writer agent can perform their functions in parallel. At 210, the test suite is run on code generated by the coder agent. At 212, the test suite results are returned to a shared message thread. The test suite results can be used to refine the code generated by the coder agent. For example, a critic agent and a debugger agent can evaluate the code and provide fixes for the code. At 214, the code and the results are evaluated for approval/rejection. For example, the engineering lead agent can determine the code does not adequately satisfy the developer-requested requirements and reject the code and the test results. If the code and the test results are rejected, then the code is returned to the coder agent and the test writer agent to execute the set of tasks and prepare a test suite for the set of tasks. If the code and the test results are approved, then at 216, the codebase is updated, committed, and pushed to source control.

It is contemplated that there can be many other uses, applications, and/or variations associated with the various embodiments of the present technology. For example, various embodiments of the disclosed technology can learn, improve, and/or be refined over time.

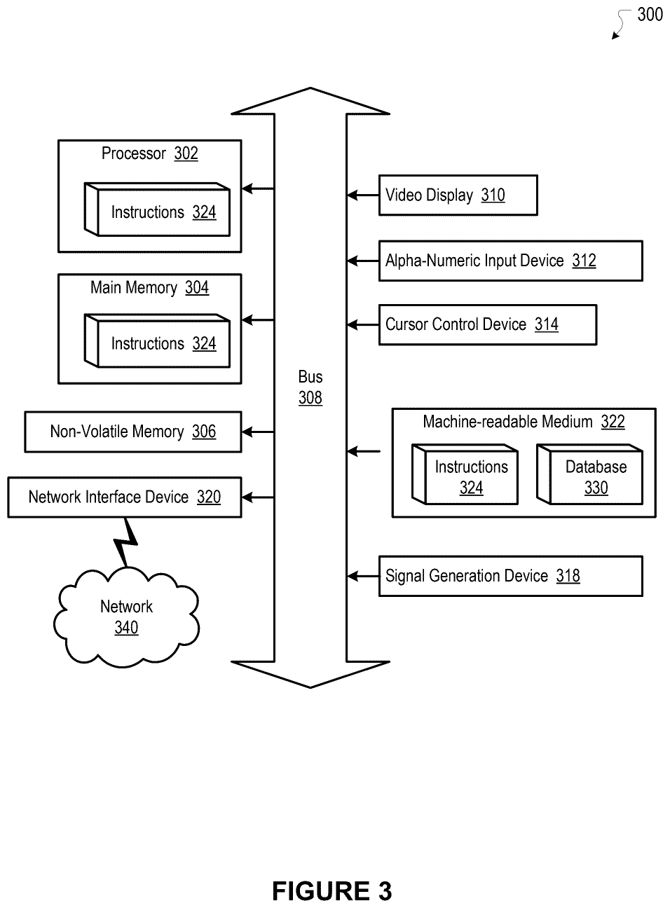

The foregoing processes and features can be implemented by a wide variety of machine and computer system architectures and in a wide variety of network and computing environments. FIG. 3 illustrates an example computer system 300 within which a set of instructions for causing the computer system to perform one or more of the embodiments described herein can be executed, in accordance with an embodiment of the present technology. The embodiments can relate to one or more systems, methods, or computer readable media. The computer system may be connected (e.g., networked) to other systems. In a networked deployment, the computer system may operate in the capacity of a server or a client system in a client-server network environment, or as a peer system in a peer-to-peer (or distributed) network environment.

The computer system 300 includes a processor 302 (e.g., a central processing unit (CPU), a graphics processing unit (GPU), or both), a main memory 304, and a nonvolatile memory 306 (e.g., volatile RAM and non-volatile RAM, respectively), which communicate with each other via a bus 308. The processor 302 can be implemented in any suitable form, such as a parallel processing system. In some instances, the example computer system 300 can correspond to, include, or be included within a computing device or system. For example, in some embodiments, the computer system 300 can be a desktop computer, a laptop computer, personal digital assistant (PDA), an appliance, a wearable device, a camera, a tablet, or a mobile phone, etc. In one embodiment, the computer system 300 also includes a video display 310, an alphanumeric input device 312 (e.g., a keyboard), a cursor control device 314 (e.g., a mouse), a signal generation device 318 (e.g., a speaker) and a network interface device 320.

In one embodiment, the video display 310 includes a touch sensitive screen for user input. In one embodiment, the touch sensitive screen is used instead of a keyboard and mouse. A computer-readable medium 322 is used to store one or more sets of instructions 324 (e.g., software) embodying any one or more of the methodologies or functions described herein. The instructions 324 can also reside, completely or at least partially, within the main memory 304 and/or within the processor 302 during execution thereof by the computer system 300. The instructions 324 can further be transmitted or received over a network 340 via the network interface device 320. In some embodiments, the computer-readable medium 322 also includes a database 330.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 306 may also be a random-access memory. The non-volatile memory 306 can be a local device coupled directly to the rest of the components in the computer system 300. A non-volatile memory that is remote from the system, such as a network storage device coupled to any of the computer systems described herein through a network interface such as a modem or Ethernet interface, can also be used.

While the computer-readable medium 322 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the computer system 300 and that cause the computer system 300 to perform any one or more of the methodologies of the present technology. The term “computer-readable medium” shall accordingly be taken to include, but not be limited to, solid-state memories, optical and magnetic media, and carrier wave signals. The term “storage module” as used herein may be implemented using a computer-readable medium.

In general, routines executed to implement the embodiments of the invention can be implemented as part of an operating system or a specific application, component, program, object, module, or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the computer system 300 and that, when read and executed by one or more processors, cause the computer system 300 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a computer-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of computer-readable media used to actually effect the distribution. Examples of computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “in various embodiments,” or the like means that a particular feature, design, structure, or characteristic described in connection with the embodiment is included in at least one embodiment of the disclosure. The appearances of, for example, the phrases “according to an embodiment”, “in one embodiment”, “in an embodiment”, “in various embodiments”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
generating a first set of tasks based on one or more requirements and one or more context;
generating a script for modification of a codebase based on performance of the set of tasks by a set of agents comprising a coder agent, a critic agent, a test writer agent, and a debugger agent; and
modifying the codebase based on the script.

2. The method of claim 1, wherein the performance of the first set of tasks comprises generation of code by the coder agent.

3. The method of claim 1, wherein the performance of the first set of tasks comprises evaluation of code generated by the coder agent by the critic agent.

4. The method of claim 1, wherein the performance of the first set of tasks comprises generation of tests by the test writer agent

5. The method of claim 1, wherein the performance of the first set of tasks comprises identification of one or more bugs by the debugger agent in code generated by the coder agent.

6. The method of claim 1, wherein the one or more requirements are generated by a requirements refiner agent based on one or more requested requirements.

7. The method of claim 1, wherein the one or more context are provided by a code context agent based on the codebase.

8. The method of claim 1, wherein the set of agents communicate via a shared message thread.

9. The method of claim 1, wherein the first set of tasks is generated by a planner agent and an engineer lead agent.

10. The method of claim 1, wherein each agent in the set of agents is configured based on a configuration file.

11. The method of claim 1, wherein each task in the first set of tasks is associated with a set of task attributes.

12. The method of claim 1, wherein the performance of the first set of tasks is based on a workflow configured based on a configuration file.

13. The method of claim 1, further comprising:
determining which agents are included in the set of agents based on the first set of tasks; and
instantiating the set of agents at runtime.

14. The method of claim 1, further comprising:
evaluating the modified codebase satisfies one or more requested requirements; and
generating a second set of tasks based on the modified codebase as additional context.

15. The method of claim 1, further comprising:
receiving feedback associated with the modified codebase; and
generating a second set of tasks based on the feedback and the modified codebase.

16. A system comprising:
a requirements refiner agent configured to generate requirements based on requested requirements;
a code context agent configured to generate context based on a codebase;
a planner agent configured to generate a set of tasks based on the requirements and the context;
an engineer lead agent configured to generate a set of targets for the set of tasks based on the requirements and the context;
a coder agent configured to generate code based on the set of tasks;
a test writer agent configured to generate a test based on the set of tasks;
a critic agent configured to evaluate the code based on the test;
a debugger agent configured to evaluate the code based on the set of tasks;
a shared message thread configured to facilitate communication between the coder agent, the test writer agent, the critic agent, and the debugger agent.

17. The system of claim 16, further comprising:
a vector database configured to store contextually labeled code provided by the code context agent.

18. The system of claim 16, wherein the planner agent and the engineer lead agent are further configured to collaboratively generate a functional/technical plan.

19. A non-transitory computer-readable storage medium including instructions that, when executed by at least one processor of a computing system, cause the computing system to perform:
generating a first set of tasks based on one or more requirements and one or more context;
generating a script for modification of a codebase based on performance of the set of tasks by a set of agents comprising a coder agent, a critic agent, a test writer agent, and a debugger agent; and
modifying the codebase based on the script.

20. The non-transitory computer-readable storage medium of claim 19, wherein the performance of the first set of tasks comprises generation of code by the coder agent, evaluation of the code generated by the coder agent by the critic agent, generation of tests by the test writer agent, and identification of one or more bugs by the debugger agent in the code generated by the coder agent.
